(19) United States
(12) Patent Application Publication
(10) Pub. No.: US 2016/0222907 A1
(43) Pub. Date: Aug. 4, 2016

(54) Cross Hatch Liner Grooves

(71) Applicant: MAHLE Inc.

(72) Inventors: Julio Cesar Llanes, Ramos Arizpe (MX); Francisco Saucedo, Ramos Arizpe (MX); Francisco Valdez, Ramos Arizpe (MX); Isidro Calderon, Ramos Arizpe (MX)

(21) Appl. No.: 14/608,328

(22) Filed: Jan. 29, 2015

(51) Int. Cl. F02F 1/00

(52) U.S. Cl. CPC F02F 1/004

(57) ABSTRACT

Cylinder liners with the external circumferential surface including a cross hatch machining pattern. Cylinder liners are cast into place as components of an engine block. The liners are positioned into place within the mold of the engine block. Molten aluminum is poured into the mold and surrounds the cylinder liners, and creates the engine block. Because of several process factors, the bond interface between the cylinder liner and engine block is sometimes inconsistent. The inconsistent bond interface between the cylinder liner and engine block may lead to premature engine failure. The cross hatch machining pattern present on the surface of the liner greatly enhances the liquid metal flow around the liner during the casting process. The enhanced molten metal flow around the liner during the casting process improves the bond interface integrity and strength between the cylinder liner and engine block.

### SUMMARY OF THE PRESENT DISCLOSURE

The present invention relates to. the outer circumferential surface of a cylinder liner. The liner is defined, as a tube shaped cylindrical line. The liner is cast into the cylinder bore of an engine block for internal combustion engines. The liner is positioned within the mold for an engine block. Molten metal is then poured into the mold to form the engine block. The present invention relates to the macroscopic recesses present on the outer circumferential surface of the cylinder liner. These macroscopic recesses are formed as channels to aid and enhance the flow of molten metal amend the outer circumference of the liner.

Conventionally, pre-formed, cast iron cylinder liners are positioned inside a die used to form a cylinder block for an internal combustion engine. Molten aluminum is injected into the die and surrounds the cylinder liner. The molten aluminum takes the shape of the die and forms the engine block shape. The cylinder liner becomes an integral part of the east aluminum engine block. Because the liner and the engine block metals are dissimilar, the interface between the aluminum metal and cast iron is inconsistent and irregular. This inconsistency manifests itself in various shapes: voids, bubbles and gaps. These inconsistencies weaken the bond strength between the liner and the engine block.

The bond strength between the liner and cylinder block must be great enough to withstand the harsh operating environment typically found in most internal combustions. Inconsistent bond interface and wreaked bond strength can cause early failure of the engine block. These failures can lead to costly repairs of the engine.

The exterior of the cylinder liner can be shot blasted to increase the surface roughness of the liner. The shot blasting process also removes the scale and other foreign materials from the outer surface of the liner. The removal of the scale and contamination may enhance the bond between the aluminum engine block and cast iron cylinder liner interface in the cast engine block.

Shot blasting mechanically deforms the outer surface of the liner. The amount of surface deformation caused by the shot blast operation does not provide adequate enhancement of the molten metal flow around the liner during the engine block casting operation. A mechanism to enhance and optimize liquid aluminum flow around the exterior surface of the liner is necessary to increase the bond adhesion between the liner and engine block.

The mechanism to increase the molten aluminum flow used must also be cost effective and easy to implement. Profit margins on engine components are very low and automotive manufacturers are unwilling to add any cost to a product.

Several methods are available for machining a liner having a cylindrical surface, e.g. an automobile crank shaft main journal, from a rough to a finished diameter. A popular method used to machine grooves into a cylindrical surface is called the plunge turning broaching method. Using this method the liner is spun about its axis, and the tool is moved into the spinning surface of the work piece. This is a tooling method embodiment used in this application. If it is not practical or desirable to spin the work piece, it may be held stationary, and the tool spun in a circular motion around the work piece.

The groves present on the cylinder liner surface are formed by a machining process. A cutting tool, is used to form the cross hatch patterned grooves ion the surface of the cylinder liner,

To form the grooves, carbide inserts are held stationary in relation to the liner surface. The carbide inserts are mounted to the surface of a cutter body using a plurality of evenly circumferentially spaced cutter inserts located at the same radius and in the same orientation. The liner is moved through the cutter body until the surface to be machined is aligned with the inserts, and then held stationary.

The grooves machined into the liner surface are formed when the spinning liner is contacted at a known fixed speed to the cutter body. The cutter body, with its axis parallel to the axis of the liner surface, is initially plunged, by moving it toward the work piece, keeping the two axes parallel. Each insert, therefore, moves m a short cutting arc relative to the liner surface as it cuts.

The entire surface of the liner is machined until the optimum number of grooves and spacing of grooves in the surface has been achieved. Various configurations are possible for the grooves, as described in more detail below. Additionally, the grooves can have a serpentine configuration to allow for the appropriate amount of liquid metal flow between the space between the liner exterior surface and the engine block interface.

The present invention improves the flow rate of liquid aluminum, improve production efficiency.

### BRIEF DESCRIPTION OF THE DRAWINGS

FIG. 1 is a sectional view of the exterior circumferential surface of a first embodiment. The surface includes a cross hatch grooved pattern.

FIG. 2 is a sectional view of the exterior circumferential surface of a second embodiment. The surface includes a second cross hatched machining pattern overlapping the first pattern.

FIG. 3 is a view of the exterior circumferential surface of a third embodiment. The entire surface of the liner includes a cross hatched machining pattern.

### DETAILED DESCRIPTION OF THE INVENTION

In the following embodiments the present invention will be described with reference to the accompanying drawings. The terms “upper”, “lower”, “upward”, “downward”, “rightward” and “leftward” used in the description denote directions merely as viewed in the drawings.

FIG. 1 illustrates a first embodiment of she cross hatch machining pattern on the outer circumferential surface of a liner 100 which defines a cylindrical bore. Illustrated in FIG. 1, the liner 100 is cylinder liner of an engine for automobiles with a single machining pattern present on the surface of the liner.

The liner 108 is moved along its axis in the direction 3 in order to produce the machined pattern illustrated in FIG. 1.

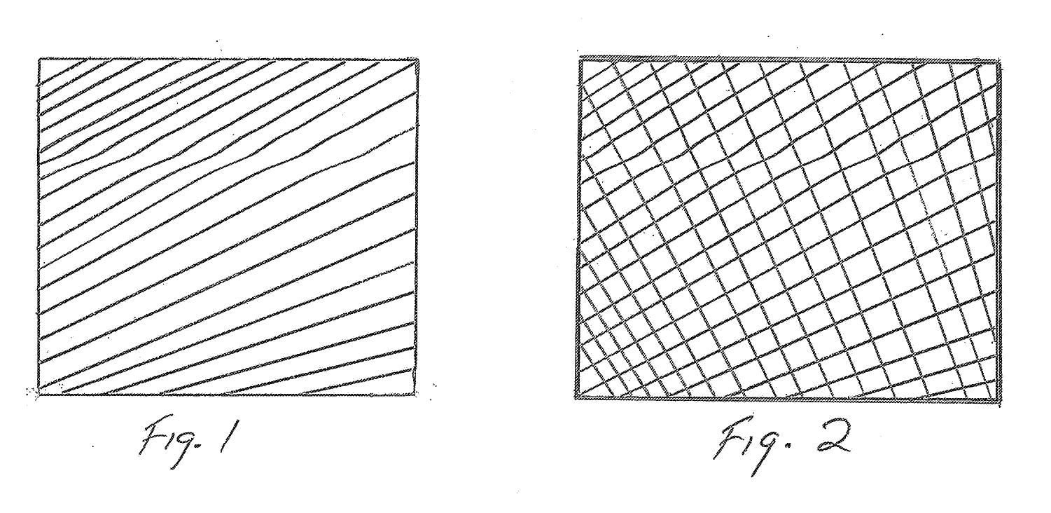

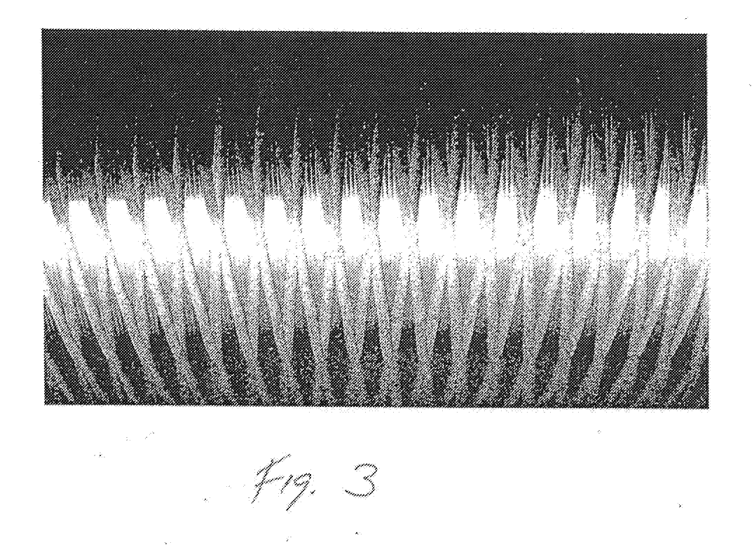

FIG. 2 illustrates a second embodiment of the cross hatch machining pattern on the outer circumferential surface of a liner 100 which defines a cylindrical bore. Illustrated in FIG. 2, the liner 100 is cylinder liner of an engine for automobiles with a cross hatch or dual machining pattern present on the surface of the liner.

The surface of the liner has the single machined pattern present on the surface of the liner, illustrated in FIG. 15 the liner 100 is moved along its axis in the direction 4 in order to produce the machined pattern illustrated in FIG. 2.

The liner 100 is moved along its axis in the direction 4 in order to produce the machined pattern illustrated in FIG. 2. The liner is rotated in the direction illustrated by the arrows 88 in FIG. 4

The finished cylinder liner outer circumferential surface claimed in the final embodiment is illustrated in FIG. 3.

The amount of metal removed by the tool in each groove feature is in a range of 1 to 3 millimeters in depth. The depth of the groove is consistent over the entire surface of the liner.

FIGS. 1 to 3 illustrate the surface pattern for the flow enhancement of molten metal around the exterior of the cylinder liner according to a disclosed embodiment.

As illustrated in FIGS. 1 to 3, the surface flow enhancement feature has a generally double teardrop shape, and is symmetric along the long axis of the grooved feature.

The entire outer circumferential surface of the liner is symmetrically covered with the cross hatch groove double tear-drop pattern illustrated in FIG. 3 The groove depth and width are consistent over the entire exterior surface of the liner.

In the disclosed embodiments, the liner is made out of cast iron. However, in alternate embodiments, any similar tough, high meting temperature material can be used.

In the disclosed embodiments, the width (W) of the surface flow enhancement groove is about 8 millimeters; and the depth (D) of the surface flow enhancement groove is about 1 millimeter. However, this is by way of example only. The width (W), and depth (D) may vary depending upon the size of the cylinder liner and die expected volume of molten metal to be poured into the mold.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein.

It further should be understood drat certain steps could be performed simultaneously, that other steps could be added, or that certain steps described herein could be omitted. In other words, the descriptions of processes herein are pro vided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

We claim:

1. A cylinder liner to be disposed in a cast engine block, the cylinder liner comprising:
an outer circumferential surface area;
a plurality of grooves present on said outer circumferential surface area,
wherein the grooves are configured such that the outer surface of the cylinder liner is regularly and evenly provided with said plurality of grooves equally spaced from, and in partial contact with the other grooves, and wherein said grooves extend completely around the outer circumferential surface area thereby increasing the flow of molten metal around the outer circumferential surface area of the cylinder liner compared to an otherwise identical cylinder liner without grooves.

2. The grooves in claim 1, wherein the grooves are formed on the entire outer circumferential surface area.

3. The grooves of claim 1, wherein the grooves are arranged in a diamond pattern.

4. The grooves of claim 1, wherein the grooves are of sufficient number and depth to enhance the flow of molten metal while maintaining the structural integrity of the grooves.
